(19) United States
(12) Patent Application Publication
(10) Pub. No.: US 2006/0238169 A1
(43) Pub. Date: Oct. 26, 2006

(54) Temperature controlled current regulator

(76) Inventor: William Baker, Indianapolis, IN (US)

Correspondence Address: CARDINAL LAW GROUP, Suite 2000, 1603 Orrington Avenue, Evanston, IL, 60201, US

(21) Appl. No.: 11/112,579

(22) Filed: Apr. 22, 2005

(51) Int. Cl. H02J 7/04

(52) U.S. Cl. 320/150

(57) ABSTRACT

A current regulation device employs an interface connector and a temperature controlled current regulator including a current path operably integrated with the interface connector. In operation, the interface connector establishes a simultaneous electrical communication of a current source and a load device to the current path of the current regulator. The temperature controlled current regulator facilitates a regulation of a flow of a current through the current path at a base regulation temperature as a function of an analog differential between the base regulation temperature and a measured operating temperature indicative of the flow of the current through the current path.

### FIELD OF THE INVENTION

The present invention generally relates to a regulation of a flow of a current through a current path of a current regulator. The present invention specifically relates to using a measure of regulator temperature to directly control a high efficiency regulation of the flow of the current through the current path of the current regulator.

### BACKGROUND OF THE INVENTION

It is known in the art to design a current regulator to regulate a flow of a current through a current path of the current regulator as a function of a digital differential between a reference temperature threshold and an operating temperature of the current regulator. Specifically, at any given point in time during the current regulation, the digital differential will equal either a low temperature logic value or a high temperature logic value. The low temperature logic value indicates the operating temperature of the current regulator is less than or equal to the reference temperature threshold whereby the current regulator operates in a low temperature/high current mode. Conversely, a high temperature logic value indicates the operating temperature of the current regulator is greater than the reference temperature threshold whereby the current regulator operates in a high temperature/low or zero current mode.

A typical design of such a current regulator employs a temperature sensor for sensing the operating temperature of the current regulator. A control circuit compares the measured temperature to a reference temperature threshold to thereby yield a digital differential between the reference temperature threshold and the operating temperature of the current regulator as measured by the temperature sensor. The control circuit switches the current regulator to the low temperature/high current mode in response to the digital differential equaling the low temperature logic value. Conversely, the control circuit switches the current regulator to the high temperature/low or zero current mode in response to the digital differential equaling the high temperature logic value.

### SUMMARY OF THE INVENTION

The present invention provides a new and unique temperature controlled current regulator for facilitating a regulation of the current path of a flow of a current through a current path at a base regulation temperature as a function of an analog differential between the base regulation temperature and a measured operating temperature of the current path. For example, with an exemplary base regulation temperature of 70° C. and an initial operating temperature of 20° C. (i.e., room temperature), the onset of current flowing through the current path as controlled by the current regulator will begin to increase the operating temperature of the current path in an upward direction toward the base regulation temperature of 70° C. The current regulator of the present invention controls, linearly or nonlinearly, the flow of the current through the current path in view of reducing the analog differential from fifty (50) to zero (0) and of attaining a relatively constant flow of current through the current path upon the operating temperature of the current path reaching the base regulation temperature of 70° C. (i.e., the analog differential is zero). In reality, for whatever reason, the operating temperature of the current path may never reach the base regulation temperature of 70° C., may exceed the base regulation temperature of 70° C., or may fluctuate about the base regulation temperature of 70° C. Nonetheless, the current regulator of the present invention will continually attempt to facilitate a regulation of the flow of the current through the current path at the base regulation temperature of 70° C. by controlling the flow of the current through the current path in view of driving the analog differential to zero.

One form of the present invention is a current regulation device employing an interface connector, and a temperature controlled current regulator including a current path operably integrated with the interface connector. In operation, the current regulator facilitates a regulation of a flow of current through the current path at a base regulation temperature as a function of an analog differential of the base regulation temperature and a measured operating temperature indicative of the flow of current through the current path.

A second form of the present invention is a temperature controlled current regulator employing a current regulation controller and a current regulation coupler including a current path. In operation, the controller electrically communicates a regulation control signal to the coupler as a function of an analog differential of a base regulation temperature and a measured operating temperature indicative of the flow of current through the current path. The coupler facilitates a regulation of a flow of a current through the current path at the base regulation temperature in response to the regulation control signal.

A third form of the present invention is a temperature controlled current regulator employing a current regulation clock, a current regulation switch controller, a current path and an electronic switch operably integrated with a current path. In operation, the regulation clock electrically communicates a clock signal to the switch controller as a function of an analog differential of a base regulation temperature and a measured operating temperature indicative of the flow of current through the current path. The switch controller electrically communicates a switch control signal to the electronic switch as a function of the clock signal. The electronic switch facilitates a regulation of a flow of a current through the current path at the base regulation temperature in response to the switch control signal.

The foregoing forms and other forms, features and advantages of the invention will become further apparent from the following detailed description of various embodiments of the present invention, read in conjunction with the accompanying drawings. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates a temperature controlled current regulator in accordance with the present invention;

FIG. 2 illustrates a flowchart representative of one embodiment of a temperature controlled current regulation method in accordance with the present invention;

FIG. 3 illustrates one embodiment in accordance with the present invention of the temperature controlled current regulator illustrated in FIG. 1;

FIG. 4 illustrates a flowchart representative of one embodiment in accordance with the present invention of the flowchart illustrated in FIG. 2;

FIG. 5 illustrates one embodiment in accordance with the present invention of the temperature controlled current regulator illustrated in FIG. 3;

FIG. 6 illustrates a flowchart representative of one embodiment in accordance with the present invention of the flowchart illustrated in FIG. 4;

FIG. 7 illustrates a first embodiment in accordance with the present invention of a current regulation coupler illustrated in FIG. 5;

FIG. 8 illustrates one embodiment in accordance with the present invention of a current regulation clock illustrated in FIG. 5;

FIG. 9 illustrates one embodiment in accordance with the present invention of a battery monitor illustrated in FIG. 5;

FIG. 10 illustrates one embodiment in accordance with the present invention of a current regulation switch controller illustrated in FIG. 5; and

FIG. 11 illustrates a second embodiment in accordance with the present invention of a current regulation controller illustrated in FIG. 5.

### DETAILED DESCRIPTION OF THE PRESENT INVENTION

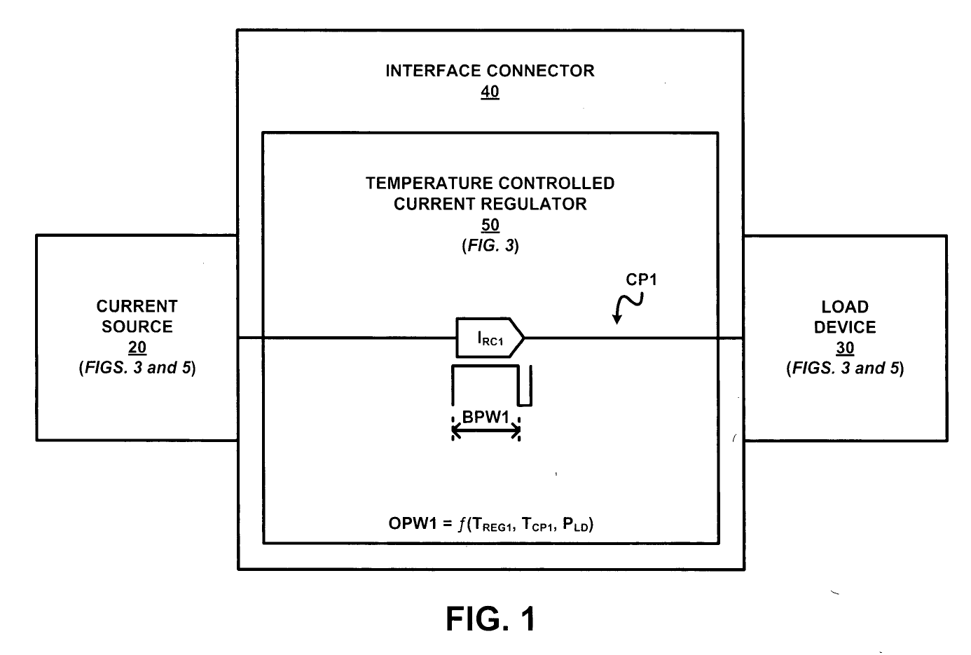

FIG. 1 illustrates a temperature controlled current regulating device of the present invention employing an interface connector 40, and a temperature controlled current regulator 50 having a current path CP1 operably integrated with the connector 40 in a conventional manner. In operation, connector 40 establishes a simultaneous electrical communication of a current source 20 and a load device 30 to current path CP1 (i.e., a direct or indirect simultaneous electrical connection of current source 20 and load device 30 to current path CP1) to thereby facilitate a flow of a current I_{RC1} from current source 20 through current path CP1 to load device 30. For purposes of the present invention, load device 30 can be any device that is operable to apply a load to regulator 50 to thereby facilitate a flow of current I_{RC1} from current source 20 through current path CP1 to load device 30. Examples of load device 30 include, but are not limited to, a battery, a motor, a heater, a lamp, a fan and any other limited input current device.

Current regulator 50 facilitates a regulation of the flow of current I_{RC1} through current path CP1 at a base regulation temperature T_{REG1} (e.g. 70° C.) as a function of an analog differential of base regulation temperature T_{REG1} and a measured operating temperature T_{CP1} indicative of the flow of current I_{RC1} through current path CP1.

Base regulation temperature T_{REG1} is the optimal temperature for regulating the flow of current I_{RC1} through current path CP1 based on the operational characteristics of current source 20, load device 30, connector 40 and/or regulator 50. In one embodiment, current source 20, load device 30, connector 40 and regulator 50 are tested under various regulation temperatures until a determination is made as to the optimal regulation temperature to serve as base regulation temperature T_{REG1}.

Measured operating temperature T_{CP1} represents an operating temperature of current source 20, load device 30, connector 40 or regulator 50 that is indicative of the flow of current I_{RC1} through current path CP1. For example, certain components of load device 30 and regulator 50 will heat up upon the onset of the flow of current I_{RC1} through current path CP1 whereby the measuring the temperature of one of the components is indicative of the flow of current I_{RC1} through current path CP1.

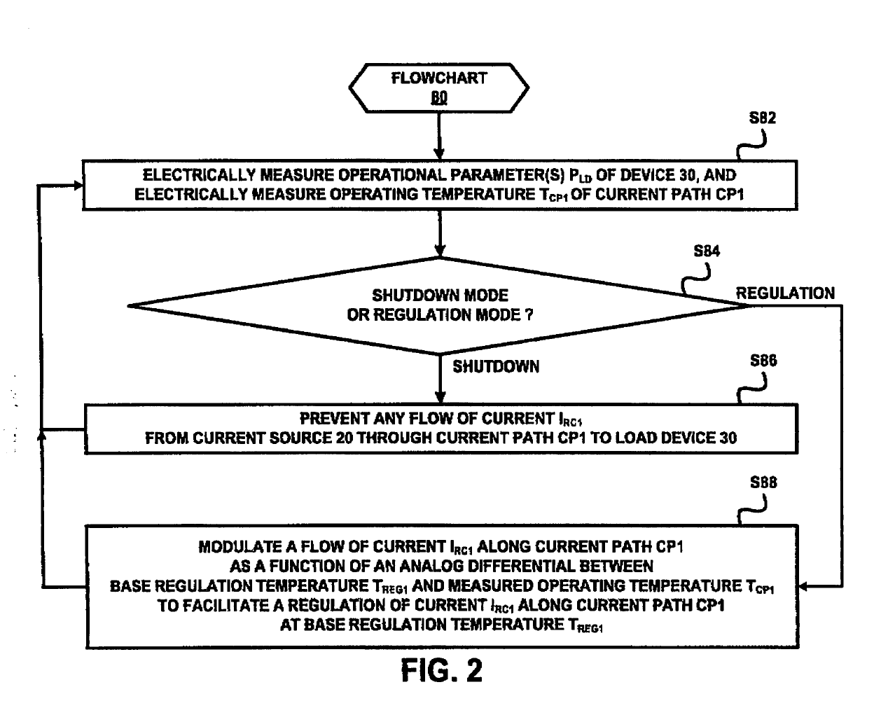

In practice, the present invention does not impose any limitations or any restrictions to the manner by which regulator 50 is structurally configured to facilitate a regulation of the flow of current I_{RC1} through current path CP1 as a function of the analog differential of base regulation temperature T_{REG1} and a measured operating temperature T_{CP1}. In one exemplary embodiment, regulator 50 implements a temperature controlled current regulation method of the present invention as represented by a flowchart 80 illustrated in FIG. 2.

Referring to FIGS. 1 and 2, flowchart 80 is implemented by regulator 50 upon connector 40 establishing a simultaneous electrical communication of current source 20 and load device 30 to current path CP1 that facilitates a flow of current I_{RC1} from current source 20 through current path CP1 to load device 30. A stage S82 of flowchart 80 encompasses regulator 50 electrically measuring one or more operational parameters P_{LD} of load device 30 (e.g., a load voltage of load device 30). In practice, the present invention does not impose any limitations or any restrictions to the manner by which regulator 50 is structurally configured to electrically sense the operational parameters P_{LD} of load device 30.

Stage S82 also encompasses regulator 50 electrically measuring operating temperature T_{OPR1} of current path CP1, which at any given point of time is a function of an ambient temperature of current path CP1 and a degree as to which current I_{RC1} has flowed through current path CP1. In practice, the present invention does not impose any limitations or any restrictions to the manner by which regulator 50 is structurally configured to electrically measure operating temperature T_{OPR1}.

Regulator 50 thereafter proceeds to a stage S84 of flowchart 80 to determine whether the measured operational parameters P_{LD} of load device 30 indicate regulator 50 needs to operated in a shutdown mode or a regulation mode. If the measured operational parameters P_{LD} of load device 30 indicate regulator 50 needs to operated in the shutdown mode, then regulator 50 proceeds to a stage S86 of flowchart 80 to operate in the shutdown mode by preventing any flow of current I_{RC1} from current source 20 through current path CP1 to device 30. Otherwise, if the measured operational parameters P_{LD} of load device 30 indicate regulator 50 needs to operated in the regulation mode, then regulator 50 proceeds to a stage S88 of flowchart 80 to modulate the flow of current I_{RC1} through current path CP1 (e.g., amplitude modulation and/or pulse width modulation) as a function of an analog differential between base regulation temperature T_{REG1} and the measured operating temperature T_{CP1} to facilitate a regulation of the flow of current I_{RC1} through current path CP1 at base regulation temperature T_{REG1}.

In one exemplary embodiment of stage S88 as shown in FIG. 1, a base pulse width BPW1 of current I_{RC1} is representative of regulation of the flow of current I_{RC1} through current path CP1 at base regulation temperature T_{REG1}, and an operating pulse width OPW1 of current I_{RC1} is modulated by regulator 50 as a function of the analog differential in a linear or non-linear manner with a view of facilitating operating pulse width OPW1 equating base pulse width BPW1 to thereby facilitate a regulation of the flow of current I_{RC1} through current path CP1 at base regulation temperature T_{REG1}. A frequency of current I_{RC1} may or may not be affected by this modulation of operating pulse width OPW1.

After the initial execution of stage S86 or stage S88, regulator 50 conditionally executes stages S82-S88 until such time the simultaneous electrical communication of current source 20 and load device 30 to current path CP1 by connector 40 has been interrupted.

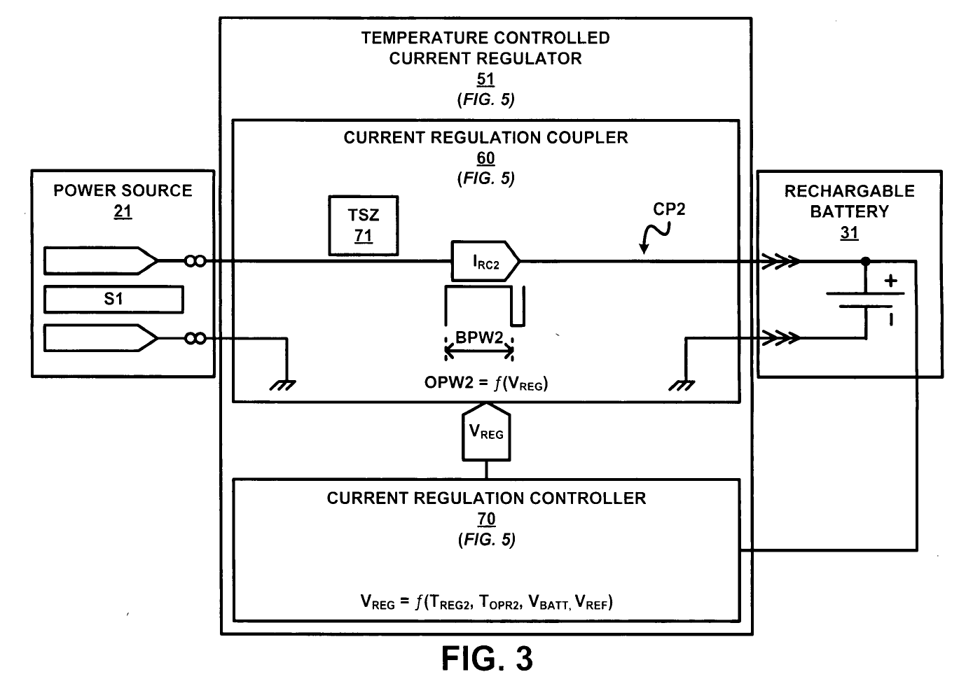

For purposes of facilitating an understanding of the present invention, the following description of various embodiments of regulator 50 as illustrated in FIGS. 3-11 will be described in context of such embodiments of regulator 50 charging load device 30 in the form of a rechargeable battery. From this description of FIGS. 3-11, those having ordinary skill in the art will appreciate other embodiments of regulator 50 in accordance with the present invention as well as other forms of load device 30 that are applicable to the present invention.

Referring to FIG. 3, an embodiment 51 of regulator 50 (FIG. 1) charges a rechargeable battery 31 in response to a current path CP2 being in simultaneous electrical communication with a power source 21 and battery 31 (i.e., current path CP2 being simultaneously connected, directly or indirectly, to power source 21 and battery 31 by an interface connector) to thereby facilitate a flow of a current I_{RC1} from current source 20 through current path CP1 to load device 30. To this end, regulator 51 employs a current regulation coupler 60 and a current regulation controller 70 to cooperatively facilitate a regulation of a flow of a current I_{RC2} through current path CP2 at a base regulation temperature T_{REG2} (e.g. 70° C.) as a function of an analog differential of a base regulation temperature T_{REG2} and a measured operating temperature T_{CP2} indicative of the flow of current I_{RC2} through current path CP2.

Base regulation temperature T_{REG2} is the optimal temperature for regulating the flow of current I_{RC2} through current path CP2 based on the operational characteristics of power source 21, battery 31, and/or regulator 51. In one embodiment, power source 21, battery 31, and regulator 51 are tested under various regulation temperatures until a determination is made as to the optimal regulation temperature to serve as base regulation temperature T_{REG2}.

Measured operating temperature T_{CP2} represents an operating temperature of power source 21, battery 31 or regulator 51 that is indicative of the flow of current I_{RC2} through current path CP2. For example, battery 31 and regulator 51 will heat up upon the onset of the flow of current I_{RC2} through current path CP2 whereby the measuring the temperature of battery 31 or regulator 51 is indicative of the flow of current I_{RC2} through current path CP2.

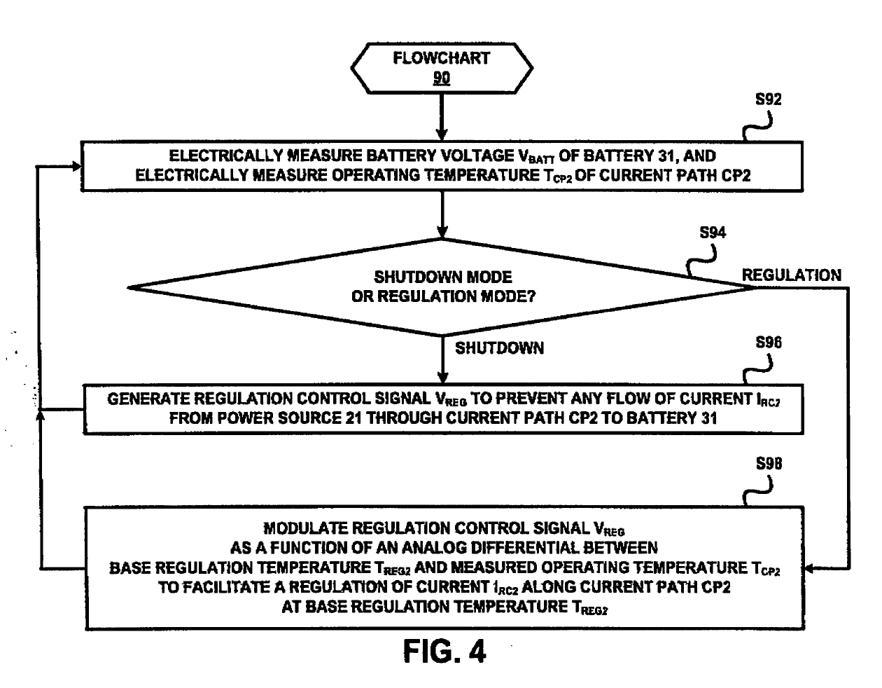

In practice, the present invention does not impose any limitations or restrictions as to manner by which coupler 60 and controller 70 are structurally configured to cooperatively facilitate a regulation of the flow of current I_{RC2} through current path CP2 at base regulation temperature T_{REG2} as a function of an analog differential of base regulation temperature T_{REG2} and measured operating temperature T_{CP2}. In one exemplary embodiment, coupler 60 and controller 70 cooperatively implement a temperature controlled current regulation method of the present invention as represented by a flowchart 90 illustrated in FIG. 4.

Referring to FIGS. 3 and 4, flowchart 90 is implemented by regulator 51 upon current path CP2 being in simultaneous electrical communication with power source 21 and battery 31 as shown to thereby facilitate a flow of current I_{RC2} from power source 21 through current path CP2 to battery 31. A stage S92 of flowchart 90 encompasses controller 70 electrically measuring a battery voltage V_{BATT} of battery 31. In practice, the present invention does not impose any limitations or any restrictions to the manner by which controller 70 is structurally configured to electrically measure battery voltage V_{BATT} of battery 31. In one exemplary embodiment, controller 70 electrically measures the battery voltage V_{BATT} of battery 31 by measuring a voltage at the positive terminal of battery 31 as shown in FIG. 3.

Stage S92 also encompasses controller 70 electrically measuring an operating temperature T_{CP2} of current path CP2, which at any given point of time is a function of an ambient temperature of current path CP2 and a degree as to which current I_{RC2} has flowed through power source 21 through current path CP2 to battery 31. In practice, the present invention does not impose any limitations or any restrictions to the manner by which controller 70 is structurally configured to electrically measure operating temperature T_{CP2} of current path CP2. In one exemplary embodiment, controller 70 electrically measures operating temperature T_{CP2} of current path CP2 by employing a temperature sensitive impedance component (“TSZ”) 71 (e.g., a thermistor) adjacent current path CP2 whereby an impedance of component 71 is indicative of operating temperature T_{CP2} of current path CP2.

Regulator 51 thereafter proceeds to a stage S94 of flowchart 90 to determine whether the measured battery voltage V_{BATT} of battery 31 indicates battery 31 is charged above a predetermined reference voltage V_{REF}, which is a function of the operating characteristics of battery 31, to thereby determine whether regulator 51 needs to operated in a shutdown mode or a regulation mode. If measured battery voltage V_{BATT} of battery 31 is greater than reference voltage V_{REF}, then controller 70 proceeds to a stage S96 of flowchart 90 to generate regulation control signal V_{REG} in a manner that prevents any flow of current I_{RC2} from power source 21 through current path CP2 to battery 31. Otherwise, if measured battery voltage V_{BATT} of battery 31 is less than or equal to reference voltage V_{REF}, then controller 70 proceeds to a stage S98 of flowchart 90 to modulate regulation control signal V_{REG} (e.g., amplitude modulation and/or pulse width modulation) as a function of an analog differential between base regulation temperature T_{REG2} and measured operating temperature T_{CP2} to thereby facilitate a regulation of the flow of current I_{RC2} through current path CP2 at base regulation temperature T_{REG2}.

In one exemplary embodiment of stage S98 as shown in FIG. 3, a base pulse width BPW2 of current I_{RC2} is representative of regulation of the flow of current I_{RC2} through current path CP2 at base regulation temperature T_{REG2}. Regulation control signal V_{REG} is modulated by controller 70 as a function of the analog differential in a linear or non-linear manner with a view of facilitating coupler 60 in equating operating pulse width OPW2 to base pulse width BPW2 to thereby facilitate a regulation of the flow of current I_{RC2} through current path CP2 at base regulation temperature T_{REG2}. A frequency of current I_{RC2} may or may not be affected by this modulation of operating pulse width OPW2.

Thereafter, coupler 60 and controller 70 conditionally execute stages S92-S98 in a cooperative manner until such time either the simultaneous electrical communication of power source 21 and battery 31 to current path CP2 has been interrupted.

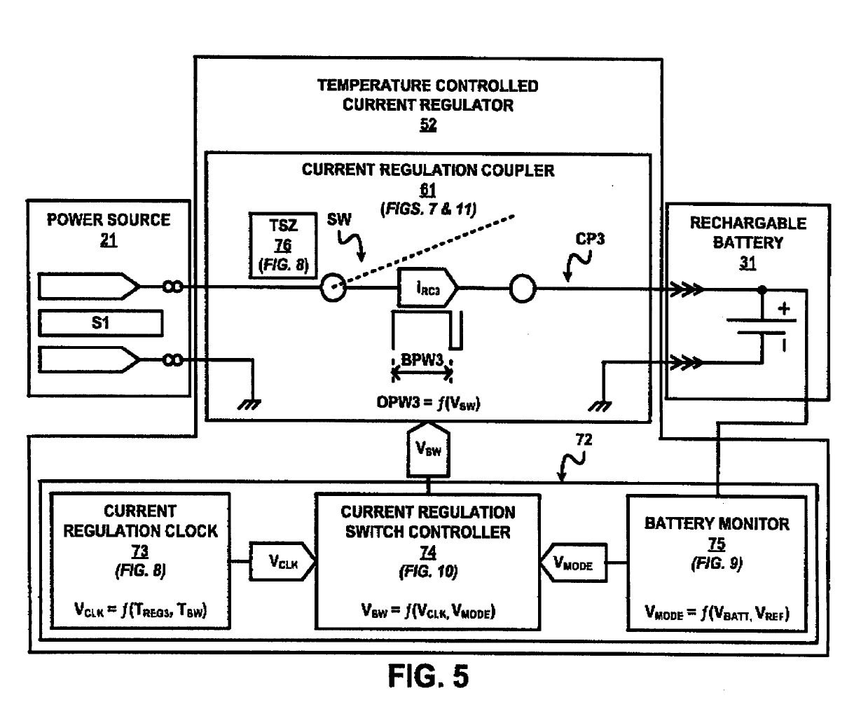

In practice, the present invention does not impose any limitations or any restrictions in the manner by which coupler 60 and controller 70 are structurally configured to implement flowchart 90. FIG. 5 illustrates an exemplary embodiment 52 of regulator 51 (FIG. 3) employing an exemplary embodiment 61 of coupler 60 (FIG. 3) and an exemplary embodiment 72 of controller 70 (FIG. 3) for cooperatively facilitate a regulation of a flow of a current I_{RC3} through current path CP3 at a base regulation temperature T_{REG3} (e.g. 70° C.) as a function of an analog differential of base regulation temperature T_{REG3} and a measured operating temperature T_{CP3}. To this end, coupler 61 employs an electronic switch SW operably integrated with current path CP3 whereby electronic switch SW is switched between an open state and a closed state as a function of a switch control signal V_{SW}.

Controller 72 employs a current regulation switch controller 74 to electrically communicate switch control signal V_{SW} to coupler 61 as a function of a clock signal V_{CLK} and a regulator mode signal V_{MODE}. A current regulation clock 73 electrically communicates clock signal V_{CLK} to controller 74 as a function of the analog differential between base regulation temperature T_{REG3} and measured operating temperature T_{CP3}, and, and a battery monitor 75 electrically communicates regulator mode signal V_{MODE} to controller 74 as a function of a comparison of battery voltage V_{BATT} AND reference voltage V_{REF}.

Base regulation temperature T_{REG3} is the optimal temperature for regulating the flow of current I_{RC3} through current path CP3 based on the operational characteristics of power source 21, battery 31, and/or regulator 52. In one embodiment, power source 21, battery 31, and regulator 52 are tested under various regulation temperatures until a determination is made as to the optimal regulation temperature to serve as base regulation temperature T_{REG3}.

Measured operating temperature T_{CP3} represents an operating temperature of power source 21, battery 31 or regulator 52 that is indicative of the flow of current I_{RC3} through current path CP3. For example, battery 31 and regulator 52 will heat up upon the onset of the flow of current I_{RC2} through current path CP3 whereby the measuring the temperature of battery 31 or regulator 52 is indicative of the flow of current I_{RC3} through current path CP3.

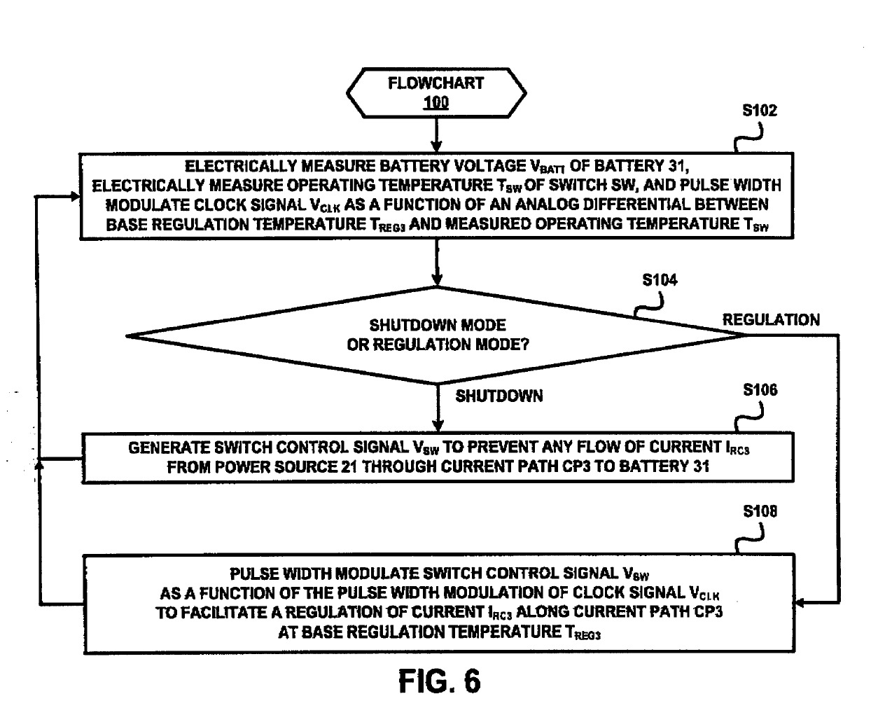

In practice, the present invention does not impose any limitations or restrictions as to manner by which coupler 61, clock 73, switch controller 74 and monitor 75 are structurally configured to cooperatively regulate a flow of current I_{RC3} 31 to thereby facilitate a regulation of a flow of a current I_{RC3} through current path CP3 at a base regulation temperature T_{REG3} as a function of the analog differential of base regulation temperature T_{REG3} and measured operating temperature T_{CP3}. In one exemplary embodiment, coupler 61, clock 73, switch controller 74 and monitor 75 cooperatively implement a temperature controlled current regulation method of the present invention as represented by a flowchart 100 illustrated in FIG. 6.

Referring to FIGS. 5 and 6, flowchart 100 is implemented by regulator 52 upon current path CP3 being in simultaneous electrical communication with power source 21 and battery 31 as shown to thereby facilitate a flow of current I_{RC3} from power source 21 through current path CP3 to battery 31. A stage S102 of flowchart 100 encompasses battery monitor 75 electrically measuring battery voltage V_{BATT} of battery 31. In practice, the present invention does not impose any limitations or any restrictions to the manner by which battery monitor 72 is structurally configured to electrically measure battery voltage V_{BATT} of battery 31. In one exemplary embodiment, battery monitor 72 electrically measures the battery voltage V_{BATT} of battery 31 by measuring a voltage at the positive terminal of battery 31 as shown in FIG. 5, and generates a regulator mode signal V_{MODE} as an indication of either switching regulator 52 to a shutdown mode (i.e., OFF) in view of battery voltage V_{BATT} being greater than reference voltage V_{REF}, or switching regulator 52 to a regulation mode (i.e., ON) in view of battery voltage V_{BATT} being less than or equal to reference voltage V_{REF}.

Stage S102 also encompasses regulation clock 73 electrically measuring operating temperature T_{SW} of electronic switch SW, which at any given point of time is a function of an ambient temperature of electronic switch SW and a degree as to which current I_{RC3} has flowed electronic switch SW. In practice, the present invention does not impose any limitations or any restrictions to the manner by which clock 73 is structurally configured to electrically measure operating temperature T_{SW} of electronic switch SW. In one exemplary embodiment, clock 73 electrically measures operating temperature T_{CP3} of electronic switch SW by employing a temperature sensitive impedance component (“TSZ”) 76 (e.g., a thermistor) adjacent electronic switch SW whereby an impedance of component 76 is indicative of the operating temperature T_{SW} of electronic switch SW, and pulse width modulates clock signal V_{CLK} as a function of an analog differential between base regulation temperature T_{REG3} and measured operating temperature T_{SW}.

Switch controller 74 thereafter proceeds to a stage S104 of flowchart 100 to determine whether mode regulation signal V_{MODE} indicates regulator 52 needs to operated in a shutdown mode or a regulation mode. If mode regulation signal V_{MODE} indicates regulator 52 needs to operated in the shutdown mode, then switch controller 74 proceeds to a stage S106 of flowchart 100 to generate switch control signal V_{SW} in a manner that prevents any flow of current I_{RC3} from power source 21 through current path CP3 to battery 31. Otherwise, if mode regulation signal V_{MODE} indicates regulator 52 needs to operated in a regulation mode, then switch controller 74 proceeds to a stage S108 of flowchart 100 to pulse width modulate switch control signal V_{SW} as a function of an analog differential between base regulation temperature T_{REG3} and measured operating temperature T_{SW} to thereby facilitate a regulation of the flow of current I_{RC3} through current path CP23 at base regulation temperature T_{REG3}.

In one exemplary embodiment of stage S108 as shown in FIG. 5, a base pulse width BPW3 of current I_{RC3} is representative of regulation of the flow of current I_{RC3} through current path CP3 at base regulation temperature T_{REG3}. Clock signal V_{CLK} is pulse width modulated by switch controller 74 as a function of the analog differential in a linear or non-linear manner with a view of facilitating switch control signal V_{SW} in switching electronic switch SW between an open state and a closed state whereby operating pulse width OPW3 of current I_{RC3} is pulse width modulated to equate base pulse width BPW2 to thereby facilitate a regulation of the flow of current I_{RC3} through current path CP3 at base regulation temperature T_{REG3}. A frequency of current I_{RC3} may or may not be affected by this modulation of operating pulse width OPW3.

Thereafter, coupler 61 and controller 72 conditionally execute stages S102-S108 in a cooperative manner until such time the simultaneous electrical communication of power source 21 and battery 31 to current path CP3 has been interrupted.

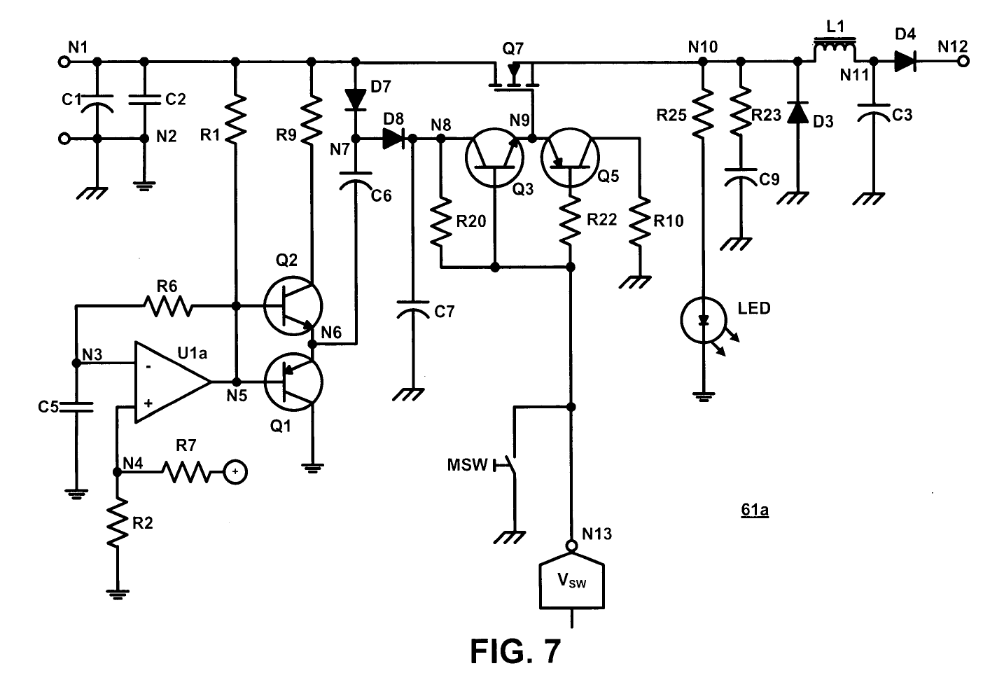

Referring to FIGS. 1-6, those having ordinary skill in the art will appreciate the varying levels of structural configurations of a temperature controlled current regulator of the present invention. The following description of FIGS. 7-11 provides schematics of exemplary structural configurations of regulator 52 (FIG. 5).

FIG. 7 illustrates one embodiment of coupler 61 (FIG. 5). A capacitor C1 (e.g., 47 μF) and a capacitor C2 (e.g., 0.1 μF) are electrically connected to a node N1 and a node N2. A resistor R1 (e.g., 3.3 KΩ) is electrically connected to node N1 and a node N5. A resistor R6 (e.g., 10 KΩ) is electrically connected to a node N5 and a node N3. A capacitor C5 (e.g., 470 pF) is electrically connected to node N3 and ground. A voltage comparator U1a (e.g., a LM339) has a non-inverting input (e.g., a pin 8 of LM339) electrically connected to a node N4, an inverting input (e.g., a pin 9 of LM339) electrically connected to node N3, and an output (e.g., a pin 14 of LM339) electrically connected to node N5. A resistor R2 (e.g., 10 KΩ) is electrically connected to node N4 and ground, and a resistor R7 (e.g., 10 KΩ) is electrically connected to node N4 and a supply voltage.

An NPN bipolar transistor Q2 (e.g., a 2N3904) has a base terminal electrically connected to node N5, a collector terminal electrically connected to a resistor R9 (e.g., 560Ω), and an emitter terminal electrically connected to a node N6. Resistor R9 is further electrically connected to node N1.

A PNP bipolar transistor Q1 (e.g., a 2N3906) has a base terminal electrically connected to node N5, a collector terminal electrically connected to ground, and an emitter terminal electrically connected to node N6. A capacitor C6 (e.g., 10 μF) is electrically connected to node N6 and a node N7.

A diode D7 (e.g., a 1N4148) is electrically connected to node N1 and node N7, and a diode D8 (e.g., a 1N4148) is electrically connected to node N7 and a node N8. A capacitor C7 (e.g., 10 μF) is electrically connected to node N8 and a common reference, and a resistor R20 (e.g., 2.2 KΩ) is electrically connected to node N8 and a node N13.

An N-channel MOSFET Q7 (e.g., a IRF7201) has a drain terminal electrically connected to node N1, a gate terminal electrically connected to a node N9, and a source terminal electrically connected to a node N10. An NPN bipolar transistor Q3 (e.g., a 2N3904) has a base terminal electrically connected to node N13, a collector terminal electrically connected to node N8, and an emitter terminal electrically connected to node N9. A PNP bipolar transistor Q5 (e.g., a 2N3906) has a base terminal electrically connected to a resistor R22 (e.g., 220Ω), a collector terminal electrically connected to a resistor R10 (e.g., 100Ω), and an emitter terminal electrically connected to node N9. Resistor R10 is further electrically connected to the common reference and resistor R22 is further electrically connected to node N13.

A manual switch MSW is electrically connected to node N13, and may be integrated with an interface connector (e.g., connector 40 shown in FIG. 1).

A resistor R25 (e.g., 3.3 KΩ) is electrically connected to node N10, and a light-emitting diode LED, which is further electrically connected to ground. A resistor R23 (e.g., 2.4 KΩ) is electrically connected to node N10, and a capacitor C9, which is further electrically connected to the common reference. A diode D3 (e.g., 1N4148) is electrically connected to node N10 and the common reference. An inductor L1 (e.g., 330 μH) is electrically connected to node N10 and a node N11. A capacitor C3 (e.g., 33 μF) is electrically connected to node N11 and the common reference. A diode D4 (e.g., 1N4148) is electrically connected to node N11 and a node N12.

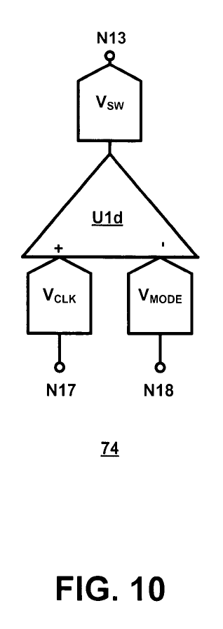

In operation, when nodes N1 and N2 are operably connected to power source 21 (FIG. 5) via a polly switch (not shown) and node N12 is operably connected to a positive terminal battery 31, MOSFET Q7 is switched between an open state and a closed state as a function of a pulse width modulation of switch control voltage V_{SW} applied to node N13 by switch controller 74 (FIG. 10) to thereby pulse-width modulate a current flowing into node N1 from power source 21 through MOSFET 67, inductor L1 and diode D4 to battery 31. Light-emitting-diode LED provides a visual indication of each time MOSFET Q7 is switched to a closed state. Those having ordinary skill in the art will appreciate that light-emitting diode LED will flicker at a rate that is not perceivable by the human eye whereby it will appear that LED is continually emitting light when coupler 61 is in the regulation mode.

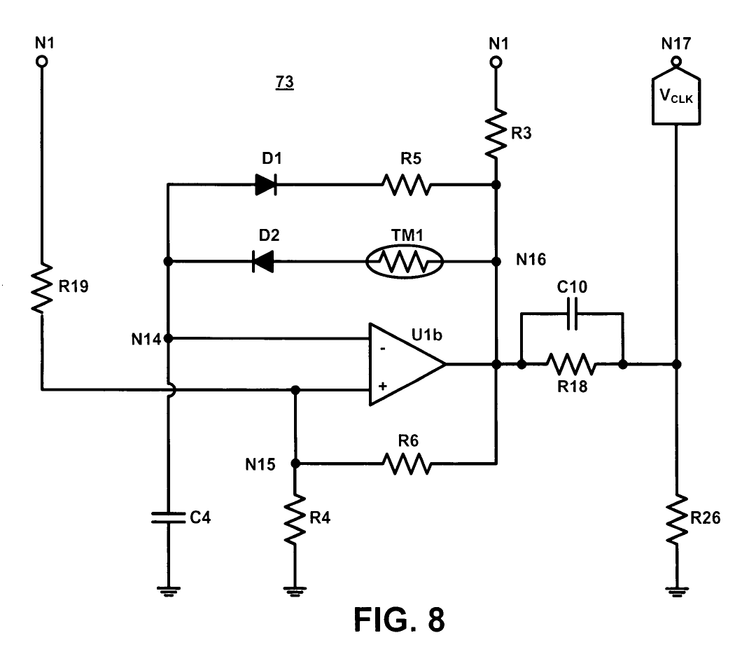

FIG. 8 illustrates one embodiment of clock 72 (FIG. 5). A resistor R19 (e.g., 1 MΩ) is electrically connected to node N1 and a node N15, and a resistor R3 (e.g., 6.8 KΩ) is electrically connected to node N1 and a node N16. A diode D1 (e.g., 1N4148) and a resistor R5 (e.g., 6.8 KΩ) are electrically connected in series between a node N14 and node N16. A thermistor TM1 (e.g., 100 KΩNTC) and a diode D2 (e.g., 1N4148) are electrically connected in series between node N16 and node N14.

A voltage comparator U1b (e.g., a LM339) has a non-inverting input (e.g., a pin 11 of LM339) electrically connected to a node N15, an inverting input (e.g., a pin 10 of LM339) electrically connected to node N14, and an output (e.g., a pin 13 of LM339) electrically connected to node N16. A resistor R6 (e.g., 1 MΩ) is electrically connected to node N16 and node N15, and a resistor R4 (e.g., 1 MΩ) is electrically connected to node N15 and ground. A capacitor C4 (e.g., a 100 pF) is electrically connected to node N14 and ground.

A capacitor C10 and a resistor R18 (e.g., 2 KΩ) are electrically connected in parallel to node N16 and a node N17. A resistor R26 (e.g., 5 KΩ) is electrically connected to node N17 and ground.

In operation, thermistor TM1 is placed adjacent MOSFET Q7 (FIG. 7) to thereby electrically measure an operating temperature of MOSFET Q7 whereby clock signal V_{CLK} is applied to node N17 with a duty cycle that is modulated as a function of an analog differential of base regulation temperature T_{REG} (e.g., 70° C.) of MOSFET Q7 and the measured operating temperature T_{Q7} of MOSFET Q7. The modulation of the duty cycle of clock signal V_{CLK} involves a variable ON time and a fixed OFF time whereby a frequency of clock signal V_{CLK} decreases as the variable ON time increases to represent a need to facilitate an increase of the measured operating temperature T_{Q7} of MOSFET Q7 in an upward direction toward base regulation temperature T_{REG}. Conversely, the frequency of clock signal V_{CLK} increases as the variable ON time decreases to represent a need to facilitate a decrease of the measured operating temperature T_{Q7} of MOSFET Q7 in a downward direction toward base regulation temperature T_{REG}.

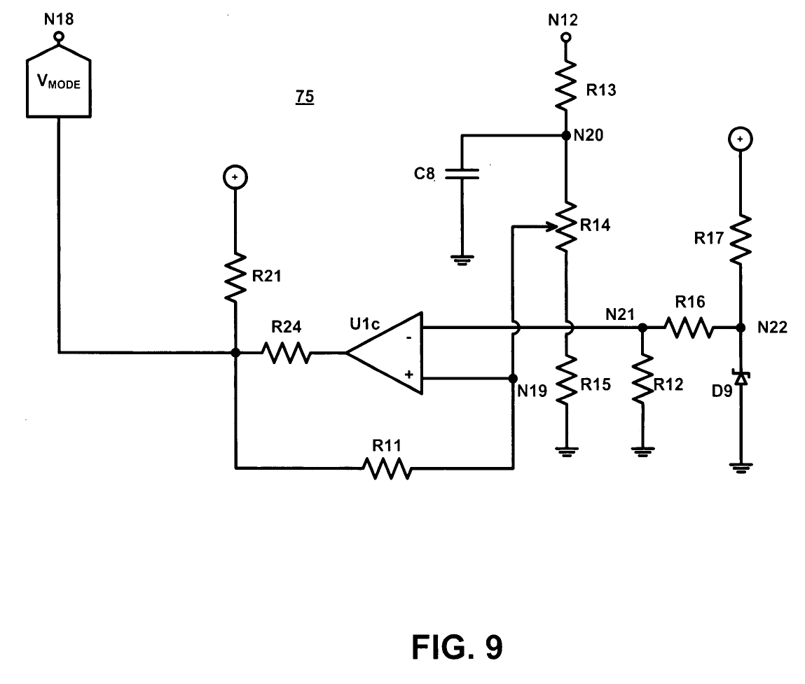

FIG. 9 illustrates one embodiment of battery monitor 74 (FIG. 5). A resistor R21 (e.g., 6.8 KΩ) is electrically coupled to a supply voltage and a node N18. A voltage comparator U1c (e.g., a LM339) has a non-inverting input (e.g., a pin 7 of LM339) electrically connected to a node N19, an inverting input (e.g., a pin 6 of LM339) electrically connected to node N21, and an output (e.g., a pin 1 of LM339) electrically connected to a resistor R24 (e.g., 3 KΩ). Resistor R24 is further electrically connected to node N18. A resistor R11 (e.g., 1 MΩ) is electrically connected to node N18 and node N19.

A resistor R17 (e.g., 1.2 KΩ) is electrically connected to a supply voltage and a node N22. A zener diode D9 is electrically connected to node N22 and ground. A resistor R16 (e.g., 4.7 KΩ) is electrically connected to node N21 and node 22, and a resistor R12 (e.g., 2.7 KΩ) is electrically connected to node N21 and ground.

A resistor R13 (e.g., 24.3 KΩ) is electrically connected to node N12 and a node N20. A capacitor C8 is electrically connected to node N20. A variable resistor R14 (e.g., 1 KΩ) and a resistor R15 (e.g., 7.15 KΩ) are electrically connected in series to node N20 and ground.

In operation, regulator mode signal V_{MODE} is applied to node N18. Regulator mode signal V_{MODE} indicates a need to switch the regulator to a regulation mode in response to battery voltage V_{BATT} as applied to the non-inverting input of amplifier U1c being equal to or less than the reference voltage V_{BATT} as applied to the inverting input of amplifier U1c. Conversely, regulator mode signal V_{MODE} indicates a need to switch the regulator to a shutdown mode in response to battery voltage V_{BATT} as applied to the non-inverting input of amplifier U1c being greater than the reference voltage V_{BATT} as applied to the inverting input of amplifier U1c. Variable resistor R14 facilitates variable settings for measuring battery voltage V_{BATT}.

FIG. 10 illustrates one embodiment of control switch 63 (FIG. 5). A voltage comparator U1d (e.g., a LM339) has a non-inverting input (e.g., a pin 5 of LM339) electrically connected to a node N17, an inverting input (e.g., a pin 6 of LM339) electrically connected to node N18, and an output (e.g., a pin 2 of LM339) electrically connected to node N13. The following Table 1 illustrates an operation of amplifier U1d.

| REGULATOR MODE | CLOCK SIGNAL | SWITCH CONTROL |
|---|---|---|
| SIGNAL V_{MODE} | V_{CLK} | SIGNAL V_{SW} |
| Logic Low | Logic High | Logic High |
| (i.e., V_{BATT} ≦ V_{REF}) | | |
| Logic Low | Logic Low | Logic Low |
| (i.e., V_{BATT} ≦ V_{REF}) | | |
| Logic High | Logic High | Logic Low |
| (i.e., V_{BATT} > V_{REF}) | | |
| Logic High | Logic Low | Logic Low |
| (i.e., V_{BATT} > V_{REF}) | | |

The logic high (i.e., ON time) of clock signal V_{CLK} is variable while the logic low (i.e., OFF time) of clock signal V_{CLK} is fixed. Thus, when regulator mode signal V_{MODE} is a logic high, the frequency of clock signal V_{CLK} decreases as the ON time of clock signal V_{CLK} increases to thereby facilitate an increase in an operating temperature T_{Q7} of MOSFET Q7 in an upward direction toward the based regulation temperature T_{REG} whereby the ON time of clock signal VCLK is fixed upon operating temperature T_{Q7} of MOSFET Q7 reaching base regulation temperature T_{REG}. Conversely, when regulator mode signal V_{MODE} is a logic high, the frequency of clock signal V_{CLK} increases as the ON time of clock signal V_{CLK} decreases to thereby facilitate a decrease in an operating temperature of MOSFET Q7 in a downward direction toward the based regulation temperature T_{REG} whereby the ON time of clock signal VCLK is fixed upon operating temperature T_{Q7} of MOSFET Q7 reaching base regulation temperature T_{REG}. Switch control voltage V_{SW} is a logic low in response to regulator mode signal V_{MODE} being a logic low whereby clock signal V_{CLK} is of no consequence at that time.

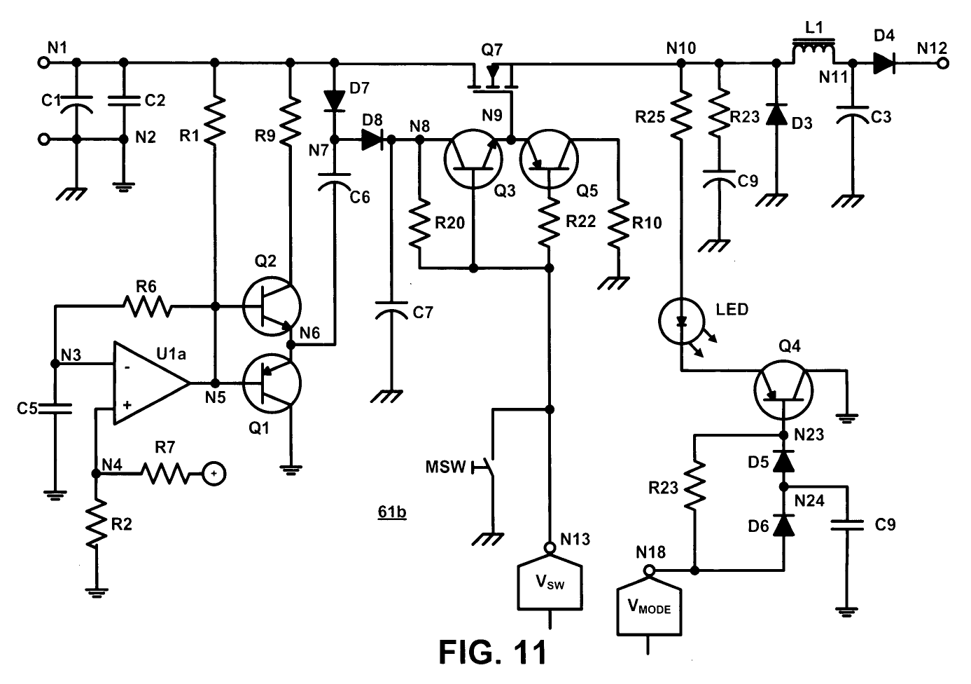

FIG. 11 is a second embodiment of coupler 61 (FIG. 7). For this embodiment, a PNP bipolar transistor Q4 (e.g., a 2N3906) has a base terminal electrically connected to a node N23, a collector terminal electrically connected to ground, and an emitter terminal electrically connected to light-emitting diode LED. A resistor R23 (e.g., 1 MΩ) is electrically connected to node N23 and node N18. A diode D5 (e.g., 1N4148) is electrically connected to node N23 and a node N24, and a diode D6 (e.g., 1N4148) is electrically connected to node N24 and node N18. A capacitor C9 (e.g., 560 pF) is electrically connected to node N24 and ground.

In operation, coupler 61 switches between modes as previously described herein in connection with FIG. 7. The only difference is the visual indication provided by light-emitting diode LED, which in this embodiment is a visual indication of the mode of the regulator. Specifically, in a regulation mode, light-emitting diode LED flicker at a rate that is not perceivable by the human eye whereby it will appear that LED is continually emitting light. As the regulator approaches a switch to the shutdown mode (i.e., as battery voltage VBATT approaches reference voltage VREF), regulation mode signal V_{MODE} will start to pulse and transistor Q4 will use this pulsing of regulation mode signal V_{MODE} to decrease the intensity of the light emitted by light-emitting diode LED until such time regulation mode signal V_{MODE} is latched to indicate the regulator should be fixed into the shutdown mode whereby light-emitting diode LED ceases emitting light.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A temperature controlled current regulation device, comprising:
an interface connector;
a temperature controlled current regulator including a current path operably integrated with the interface connector; and
wherein the temperature controlled current regulator is operable to facilitate a regulation of a flow of a current through the current path at a base region temperature as a function of an analog differential between the base regulation temperature and a measured operating temperature indicative of the flow of the current through current path.

2. The temperature controlled current regulation device of claim 1, wherein the interface connector is operable to establish a simultaneous electrical communication of the current path to a current source and a load device.

3. The temperature controlled current regulation device of claim 1, wherein the temperature controlled current regulator includes:
means for measuring an operating temperature of the current path.

4. The temperature controlled current regulation device of claim 1, wherein the temperature controlled current regulator includes:
means for modulating the flow of the current through the current path as the function of the analog differential between the base regulation temperature and the measured operating temperature to thereby facilitate the regulation of the flow of the current through the current path at the base regulation temperature.

5. The temperature controlled current regulation device of claim 1, wherein the temperature controlled current regulator includes:
means for visually indicating a level of the flow of the current through the current path.

6. A temperature controlled current regulator, comprising:
a current regulation controller;
a current regulation coupler including a current path;
wherein the curt regulation controller is operable to electrically communicate a regulation control signal to the current regulation coupler as a function of an analog different between a base regulation temperature and a measured operating temperature indicative of a flow of a current though the current path; and
wherein the current regulation coupler is operable to facilitate a regulation of the flow of the current though the current path at the base regulation temperature in response to the regulation control signal.

7. The temperature controlled current regulator of claim 6, wherein the current regulation controller includes:
means for measuring an operating temperature of the current path.

8. The temperature controlled current regulator of claim 6, wherein the current regulation controller includes:
means for modulating the current regulation signal as the function of the analog differential between the base regulation temperature and the measured operating temperature to thereby facilitate the regulation of the flow of the current through the current path at the base regulation temperature.

9. The temperature controlled current regulator of claim 8, wherein the current regulation coupler includes:
means for modulating the flow of the current through the current path as a function of a modulation of the current regulation signal by the current regulation controller.

10. The temperature controlled current regulator of claim 6, wherein the current regulation coupler includes:
means for visually indicating a level of the flow of the current through the current path.

11. A temperature controlled current regulator, comprising:
a current regulation clock;
a current regulation switch controller;
a current regulation coupler including an electronic switch operably integrated with a current path;
wherein the current regulation clock is operable to electrically communicate a clock signal to the current regulation switch controller as a function of an analog differential between a base regulation temperature and a measured operating temperature indicative of a flow of a current trough the current path;
wherein the current regulation switch controller is operable to electrically communicate a switch control signal to the electronic switch as a function of the clock signal; and
wherein the electronic switch is operable to facilitate a regulation of the flow of the current through the current path at the base regulation temperature in response to the switch control signal.

12. The temperature controlled current regulator of claim 11, wherein the current regulation clock includes:
means for measuring an operating temperature of the electronic switch.

13. The temperature controlled current regulator of claim 11, wherein the current regulation clock includes:
means for modulating the clock signal as the function of the analog differential between the base regulation temperature and the measured operating temperature.

14. The temperature controlled current regulator of claim 13, wherein the regulation switch controller includes:
means for modulating the switch control signal as a function of a modulation of the clock signal by the current regulation clock.

15. The temperature controlled current regulator of claim 14, wherein the electronic switch is operable to modulate the flow of the current through the current path as a function of the modulation of the switch control signal.

16. The temperature controlled current regulator of claim 11, wherein the current regulation coupler includes:
means for visually indicating a level of the flow of the current through the current path.
